(19) United States
(12) Patent Application Publication
(10) Pub. No.: US 2007/0174113 A1
(43) Pub. Date: Jul. 26, 2007

(54) Enterprise incentive management

(76) Inventor: Marc Rowen, Dublin, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(21) Appl. No.: 10/426,498

(22) Filed: Apr. 29, 2003

(51) Int. Cl. G06Q 30/00

(52) U.S. Cl. 705/14

(57) ABSTRACT

The invention include systems and methods of managing incentives within an organization. In one aspect of the invention, this includes approval of a new or modified incentive plan, or of new or modified incentive distributions. In another aspect of the invention, this includes providing notice of a new or modified incentive allocation plan, or of new or modified incentive distributions. Business objects are identified, to receive requests for approval or to receive notice, by navigating a hierarchical data structure representative of relationships between business objects of the organization. In some embodiments, specific roles associated with these business objects are considered in the identification process.

### BACKGROUND

1. Field of the Invention

The invention is in the field of computer science and more specifically in the field of transaction management.

2. Prior Art

In a typical organization incentives provided to employees, contractors, and business partners may include commissions, bonuses, privileges, and travel. For example, it is not unusual for members of a sales team to receive commissions and trips as a reward for sales. In many cases, the incentives received by an individual are dependent not only on that individual's performance but also on the performance of a team, department, or entire enterprise. In large organizations management of incentive allocation plans and resulting incentive distributions are difficult tasks.

Typically, incentive plans are managed by an ad hoc set of rules or spread sheet calculations used to calculate incentive distributions. This situation results in a number of problems. For example, when an individual moves within an enterprise organization, rules associated with their incentive allocation must be manually modified. Likewise, special incentives such as one time promotions or rewards for particular events are difficult to implement within an established incentive plan or calculated set of incentive distributions. Further, making changes to incentive plans and approving changes to incentive distributions beyond those generated from the plans in an efficient and controlled manner is beyond the capabilities of the prior art.

### SUMMARY OF THE INVENTION

Embodiments of the invention include systems and methods of managing incentive transactions. Relationships between business objects (e.g. personnel, departments, contractors, or other aspects of an enterprise) and roles that the business objects are allowed to take, are used to manage changes to an incentive plan and/or incentive distributions. Typically, these business objects are related using a hierarchical data structure. Nodes within the data structure are associated with the business objects and their positions within the hierarchy are representative of an organization of the enterprise. These nodes are also optionally associated with plan rules, included in the incentive plan. The incentive plan being configured for calculating incentive distributions to the associated business objects. For example, in some embodiments a group manager is associated with a node at a higher level than nodes with which members of the group are associated.

In some embodiments, the hierarchical data structure is used to determine an approval for a change in an incentive plan or for a change in incentive distributions. For example, when data within application rules or incentive distributions are modified, the hierarchical data structure is used to navigate from a node associated with the changed data to a node associated with a business object having an “approval” role. This business object is then requested to approve the change.

In some embodiments, the hierarchical data structure is used to provide notice of a change in an incentive plan or of a change in an incentive distribution. For example, when a rule used to generate the incentive distribution is modified, the hierarchical data structure is used to navigate to a node associated with a business object whose incentive is affected by the change in the rule. Likewise, when an incentive distribution is modified, the hierarchical data structure is used to navigate to a node associated with a business object whose incentive distribution is affected by the change.

In various embodiments, the mechanisms of identifying business objects using the hierarchical data structure and providing notice to these business objects, are used to provide notice of other business transactions. For example, in some embodiments, these methods are used to provide notice of quotas, report progress toward quotas, report calculation of proposed or intermediate incentive distributions, or the like.

In some embodiments, the hierarchical data structure is used to generate both approval and notice.

Various embodiments of the invention include a system for administrating incentives, the system comprising a computing system including a data modification engine configured to modify incentive allocation data, the incentive allocation data configured for allocation of incentives, an approval engine configured to use a hierarchical data structure to identify a business object configured to receive a request for approval of a modification to the incentive allocation data, the hierarchical data structure configured to store organizational data representative of relationships between business objects, a processing unit configured to execute the approval engine, an output interface configured to output the request for approval, and storage configured to store the incentive allocation data and the organizational data.

Various embodiments of the invention include a system for administrating incentives, the system comprising a computing system including means for modifying incentive allocation data, the incentive allocation data configured for allocation of incentives, means for using relationships between business objects to identify a business object configured to receive a request for approval of a modification to the incentive allocation data, means for executing the approval engine, means for outputing the request for approval, and means for storing the incentive allocation data and the organizational data.

Various embodiments of the invention include a request to approve a modification to incentive allocation data, the incentive allocation data modified using a data modification engine, the request being text or graphics, generated by an approval engine configured to identify a business object having an approval role and configured to receive the request for approval of a modification to the incentive allocation data.

Various embodiments of the invention include a computer readable medium having embodied thereon data, the data comprising computer code configured for modifying incentive allocation data, the incentive allocation data configured for allocation of incentives, for using a hierarchical data structure to identify a business object configured to receive a request for approval of a modification to the incentive allocation data, the hierarchical data structure configured to store organizational data representative of relationships between business objects, for executing the approval engine, and for outputing the request for approval.

Various embodiments of the invention include a system for administrating incentives, the system comprising a computing system including a data modification engine configured to modify incentive allocation data, the incentive allocation data configured for allocation of incentives, a notification engine configured to use a hierarchical data structure to identify a business object configured to receive a notification of a modification to the incentive allocation data, the hierarchical data structure configured to store organizational data representative of relationships between business objects, a processing unit configured to execute the notification engine, an output interface configured to output the notification, and storage configured to store the incentive allocation data and the organizational data.

Various embodiments of the invention include a system for administrating incentives, the system comprising a computing system including means for modifying incentive allocation data, the incentive allocation data configured for allocation of incentives, means for using a hierarchical data structure to identify a business object configured to receive a notification of a modification to the incentive allocation data, the hierarchical data structure configured to store organizational data representative of relationships between business objects, means for executing the notification engine, means for outputing the notification, and means for storing the incentive allocation data and the organizational data.

Various embodiments of the invention include a notification of a modification to incentive allocation data, the incentive allocation data modified using a data modification engine, the notification including text or graphics and being generated by a notification engine configured to use a hierarchical data structure to identify a business object affected by the modification to the incentive allocation data, the hierarchical data structure configured to store organizational data representative of relationships between business objects.

Various embodiments of the invention include a system for administrating incentives, the system comprising a computing system including a data modification engine configured to modify incentive allocation data, the incentive allocation data configured for allocation of incentives, an approval engine configured to use a hierarchical data structure to identify a business object configured to receive a request for approval of a modification to the incentive allocation data, the hierarchical data structure configured to store organizational data representative of relationships between business objects, a notification engine configured to use the hierarchical data structure to identify a business object configured to receive a notification of a modification to the incentive allocation data, the business object configured to receive a notification being a business object affected by the modification to the incentive allocation data, a processing unit configured to execute the approval engine and the notification engine, an output interface configured to output the request for approval and to output the notification, and storage configured to store the incentive allocation data and the organizational data.

Various embodiments of the invention include a method of administrating compensation, the method comprising modifying incentive allocation data, identifying a first business object associated with a hierarchical data structure representative of a relationship between the first business object and a second business object, the identification being made by navigating within the data structure from the second business object to the first business object, and notifying the first business object of the modification of the incentive allocation data.

Various embodiments of the invention include a method of administrating transactions, the method comprising modifying transaction data, identifying a first business object having an approval role, the first business object being associated with a hierarchical data structure representative of a relationship between the first business object and a second business object, the identification being made using the hierarchical data structure representative of a relationship between the first business object and a second business object, requesting an approval for the change in the transaction data, from the first business object, and processing a response to the request, the response being received from the first business object.

### BRIEF DESCRIPTION OF THE VARIOUS VIEWS OF THE DRAWING

FIG. 1 is a block diagram of an incentive management system, according to various embodiments of the invention;

FIG. 2 is an illustration of a hierarchical data structure, according to various embodiments of the invention;

FIG. 3 is a flowchart illustrating a method of approving modification of incentive distributions, according to various embodiments of the invention; and

FIG. 4 is a flowchart illustrating a method of providing notice relating to an incentive distribution, according to various embodiments of the invention.

### DISCLOSURE OF THE INVENTION

The invention includes systems and methods of seeking approval or providing notice of modification to an incentive allocation plan and/or modification to incentive distributions. The incentive allocation plan typically includes one or more plan rules configured to determine incentive distributions to an associated business object. The plan rules include plan rules used to determine if a business object should receive an incentive and calculation rules used to calculate the amount of the incentive. For example, an plan rule may indicate that an associated salesperson should receive an incentive for her sales in a particular district and a calculation rule may indicate that the incentive should be a 2% commission. When applied to one or more transaction this plan rule may result in a calculated incentive distribution specifying that she should receive funds totaling $1000. In other examples, incentive distributions may involve travel benefits, benchmarks (quotas), penalties, or the like. In some embodiments, incentive distributions are managed as transactions between an enterprise and a business object receiving the incentive. Typically, the aspect of an incentive plan or incentive distribution for which approval is sought or notice is provided relates to a modification of existing data, however, in some embodiments, the invention is used to provide approval or notice relating to a new incentive allocation plan and/or new incentive distribution.

In various embodiments of the invention, the associated approval is sought or notice is provided using a hierarchical data structure representative of relationships between business objects configured to provide the approval and/or receive the notice, respectively. This hierarchical data structure is optionally a preexisting data structure representative of an organization of the enterprise. In typical embodiments, various nodes of the hierarchical data structure are associated with business objects configured to receive incentives as well as business objects configured to approve and/or receive notice. In these embodiments, those business objects configured to provide approval are associated with an “approval” role. The hierarchical data structure is used to identify which business object should receive a request for approval or which business object should receive notice of a modification to an incentive distribution or an allocation plan.

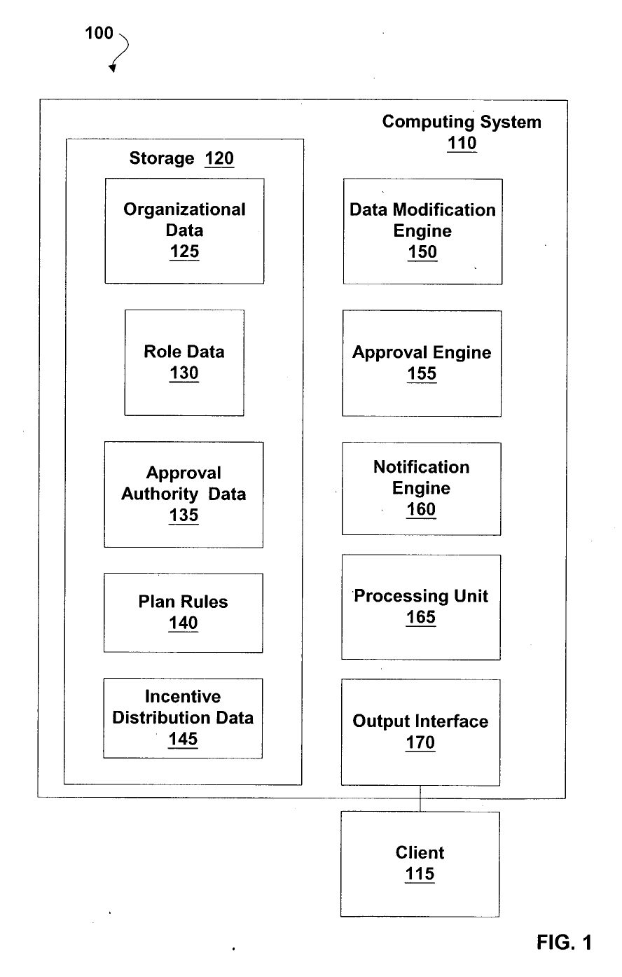

FIG. 1 is a Block Diagram of an Incentive Management System, generally designated 100, according to various embodiments of the invention. Incentive Management System 100 includes a Computing System 110 and an optional Client 115. Computing System 110 includes a Storage 120 configured to store data used by Enterprise Incentive Management System 100. In various embodiments, Storage 120 is configured to store Organizational Data 125, Role Data 130, and optional Approval Authority Data 135. Organizational Data 125 is comprised of information representative of relationships between business objects within an enterprise. These relationships form a hierarchical data structure. The related business objects are typically people, but, in some embodiments, may also be groups, divisions, contractors, subsidiaries, channel partners, or the like.

Each business object is optionally associated with Role Data 130. Role Data 130 includes information regarding the roles a specific business object can take. For example, in one embodiment, a first business object has an “approval” role while a second business object has a “receive incentive” role. Other, optional, roles are described in co-pending U.S. patent application Ser. No. ______ entitled “Hierarchical Transaction Filtering,” filed Apr. 29, 2003. In some embodiments, roles are responsive to relationships between more than one business object. For example, a business object may have an approval role with respect to business objects at a lower level in the hierarchical data structure and have a “receive notice” role with respect to business objects at a higher level in the hierarchical data structure. In other words, in these embodiments, the expression of a role is responsive to relationships between business objects within the hierarchical data structure.

Those business objects having an “approval” role are optionally associated with Approval Authority Data 135. Approval Authority Data 135 is indicative of the authority of a business object to provide approval. For example, in some embodiments, Approval Authority Data 135 includes a limit on a dollar value of an approval a particular business object can grant. In some embodiments, Approval Authority Data 135 includes, for a particular business object, a maximum number of approvals, a limited set of other business objects from which approvals can arise and be approved, a specific department from which approvals can arise and be approved, or the like. In some embodiments, Approval Authority Data 135 includes information relating to incremental approvals wherein approval from a particular business object is needed but not of sufficient authority to generate a final approval without approval from an other business object.

Storage 120 is further configured to store Plan Rules 140 and Incentive Distribution Data 145, Plan Rules 140 and Incentive Distribution Data 145 being two types of incentive allocation data. Plan Rules 140 are representative of an incentive allocation plan configured for determining Incentive Distribution Data 145 characterizing incentive distributions to associated business objects. In some embodiments, Plan Rules 140 are generated and/or Incentive Distribution Data 145 are determined using systems and methods described in co-pending U.S. patent application Ser. No. ______ entitled “Hierarchical Transaction Filtering,” filed Apr. 29, 2003. Additions or changes to Plan Rules 140 or Incentive Distribution Data 145 are events for which approval may be sought and/or notice provided. In some embodiments, Plan Rules 140 or Incentive Distribution Data 145 include data that has been modified but for which the modification has not received a final approval. These data are considered “pending,” while Plan Rules 140 or Incentive Distribution Data 145 that have received a final approval are considered “approved.” Storage 120 includes one or more data storage device, such as random access memory, a hard disk, or the like, and is optionally distributed.

Computing System 110 further includes an optional Data Modification Engine 150. Data Modification Engine 150 includes computer code configured for modifying Plan Rules 140 or Incentive Distribution Data 145 in response to input. In various embodiments, this input is received from a person, such as a manager or compensation administrator, or from an external computing process. Data Modification Engine 150 optionally further includes computer code for generation of an interface for use by the compensation administrator, the manager, or the like. For example, in some embodiments, Data Modification Engine 150 includes computer code configured to generate meta-language data that can be displayed as an interface to a compensation administrator using a browser. When Data Modification Engine 150 is used to modify Plan Rules 140 or Incentive Distribution Data 145, the changes are optionally flagged as “Pending Approval.” In this case a copy of the unmodified data is retained for possible restoration by Data Modification Engine 150.

Following modification of Plan Rules 140 or Incentive Distribution Data 145, an Approval Engine 155 is optionally used to change the status of the modification from “Pending Approval” to “Approved” or to “Not Approved.” Approval Engine 155 includes computer code configured to determine a type of approval required, attempt to obtain a manual approval if required, and change the status of the modification to Plan Rules 140 to “Approved” or to “Not Approved.” Further details of these processes are described elsewhere herein. In some embodiments, Data Modification Engine 150 and Approval Engine 155 are combined in a single set of computer code.

Following modification of Plan Rules 140 or Incentive Distribution Data 145, a Notification Engine 160 is optionally used to notify interested parties of the modification. Notification Engine 160 includes computer code configured to determine who to notify and to provide the notification. In some embodiments, Data Modification Engine 150 and Notification Engine 160 are combined in a single set of computer code.

Computing System 110 further includes a Processing Unit 165 configured to manage access to Storage 120 and execute computer code included in Data Modification Engine 150, Notification Engine 160 and/or Approval Engine 155. In a typical embodiment, Processing Unit 165 includes an integrated circuit such as a central processing unit or logic circuit. Some embodiments include a plurality of Processing Unit 165 and Computing System 110 is optionally a distributed computing system.

Computing System 100 includes an Output Interface 170 configured for communication with a user. In some embodiments, Output Interface 170 is a display responsive to Processing Unit 165. In some embodiments, Output Interface 170 is a communications interface or device configured to communicate with Client 115. For example, in one embodiment, Output Interface 170 is a network interface coupled to a computer network.

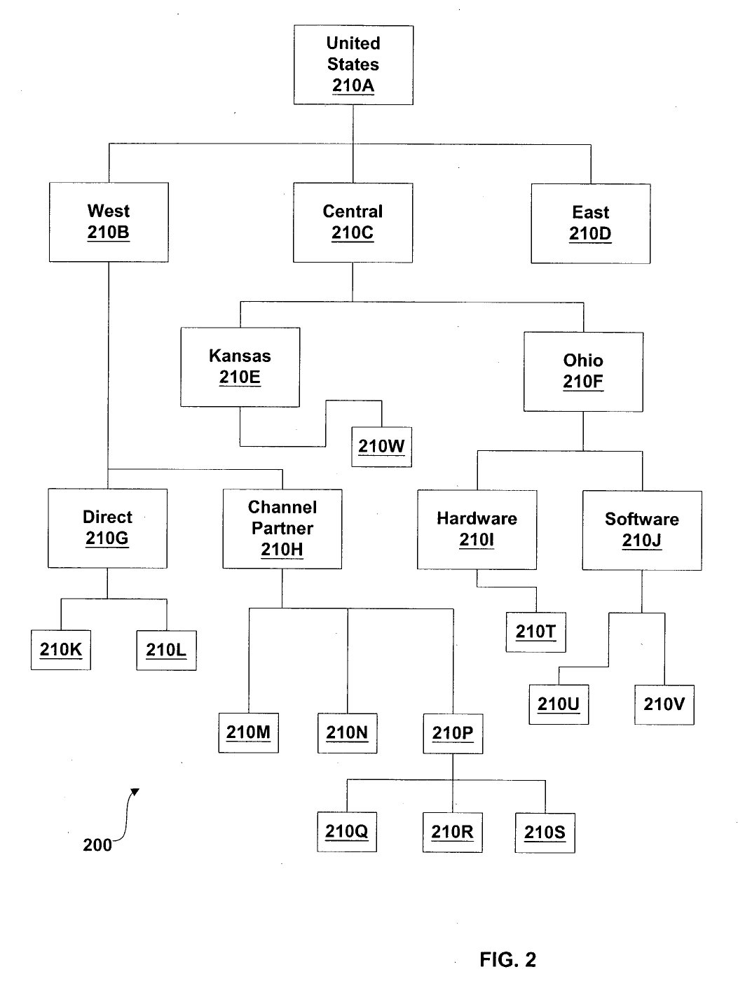

FIG. 2 illustrates a Hierarchical Data Structure, generally designated 200, according to various embodiments of the invention. In these embodiments, Hierarchical Data Structure 200 is included in Organizational Data 125 (FIG. 1) and is used to store relationships between a set of Business Objects, 210A-210W. Business Objects 210A-210W include geographic regions (210A-210F), sales channel types (210G-210H), product types (210I-210J), individual sales people (210K-210W), or the like. In this example, Business Object 210A is represented by a root node of Hierarchical Data Structure 200. Business Objects 210B-210J and 210P are represented by intermediate nodes and Business Objects 210K-210N and 210Q-210W are represented by leaf nodes.

In some embodiments, an individual sales person is optionally associated with more than one Business Object 210. For example, a sales person may be involved with both direct sales in the west and hardware sales in Ohio, and thus be both Business Objects 210K and 210T. A sales person is also optionally represented by an intermediate node such as Business Object 210P. The relationships between Business Object 210P (intermediate node) and Business Objects 210Q-210S (leaf nodes) may, for example, be that of sales group leader and sales group members. Some of Business Objects 210A-210W are optionally representative of different organizations (e.g., companies, divisions, or groups). For example, Business Objects 210M-210S may be representative of a separate channel partner company.

In a typical embodiment, incentives are allocated to Business Objects 210A-210W using Incentive Distribution Data 145 (FIG. 1). Incentive Distribution Data 145 is optionally generated using an incentive allocation plan characterized by Plan Rules 140. In some embodiments, Plan Rules 140 are generated using data associated with each of Business Objects 210A-210W. See, for example, the systems and methods described in U.S. patent application Ser. No. ______ entitled “Hierarchical Transaction Filtering,” filed Apr. 29, 2003.

The embodiment of Hierarchical Relationship Structure 200 illustrated in FIG. 2 includes a single parent node for each node other than the root node (Business Object 210A). This structure simplifies navigation between nodes of the data structure. However, in alternative embodiments a particular Business Object 210 may have more than one parent node. Successful navigation between nodes is possible as long as there are a finite number of paths between each node and the root node, (i.e., no circular paths exist). Thus, while a simple hierarchical data structure is disclosed for illustrative purposes, embodiments of the invention include other relational data models accommodating a hierarchical characterization of nodes and their associated Business Objects 210A-210W. In some embodiments of the invention, not all nodes are associated with a member of Business Objects 210A-210W. For example, some data structures, such as a binary tree representation of Hierarchical Data Structure 200, include nodes used primarily for navigation. In some embodiments, only leaf nodes are associated with a member of Business Objects 210A-210W and intermediate nodes are used for navigating the data structure.

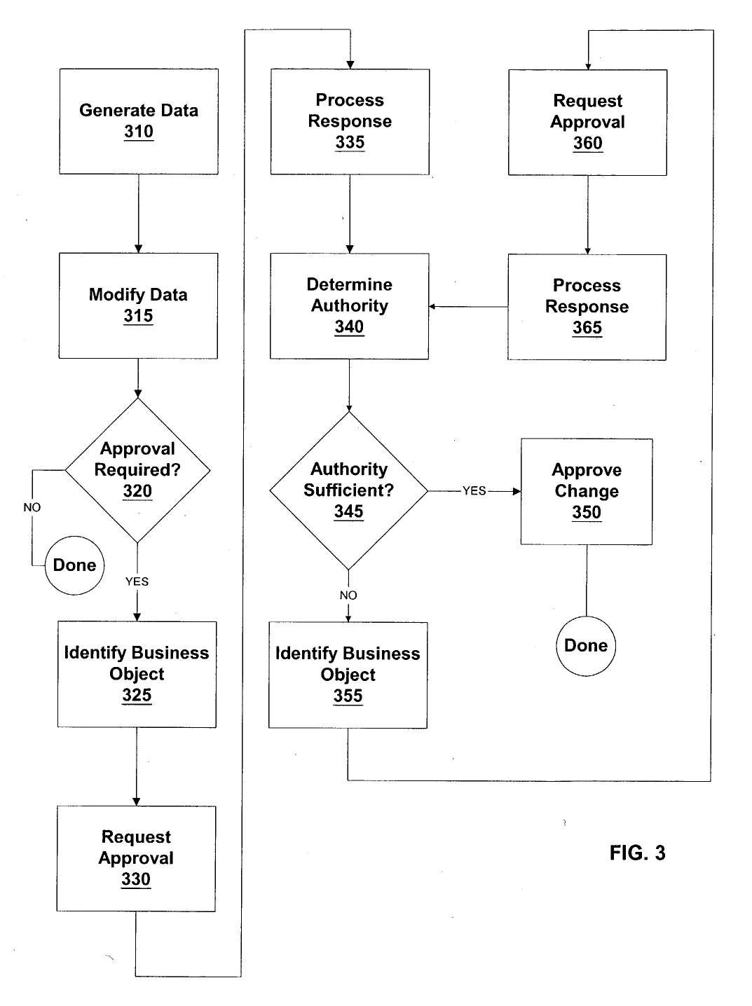

FIG. 3 is a flowchart illustrating a method of approving modification of incentive distributions according to various embodiments of the invention. Similar methods are optionally used for approving modification of Plan Rules 140. In an optional Generate Data Step 310, Incentive Distribution Data 145, characterizing an incentive to be distributed to a business object, is generated. Generate Data Step 310 is not required when the Incentive Distribution Data 145 to be modified already exists. In some embodiments, Incentive Distribution Data 145 are generated using Plan Rules 140. In some embodiments, Incentive Distribution Data 145 are generated by manual input.

In a Modify Data Step 315, Incentive Distribution Data 145 are modified using Data Modification Engine 150. In various embodiments, the modification includes addition of new Incentive Distribution Data 145 and/or changes to previously existing Incentive Distribution Data 145. In some embodiments, the modification in Modify Data Step 315 includes generation of new Incentive Distribution Data 145, new Plan Rules 140, and/or a new incentive allocation plan. Modification may be responsive to input from a compensation administration, manager, external process, or the like. In some embodiments, the source of the input to which modification is responsive is one of Business Objects 210A-210W associated with Hierarchical Data Structure 200. For example, in one embodiment, Business Object 210F is a manager of an Ohio division and this manager decides to modify the incentives given to hardware and software groups. In some embodiments, modification of Plan Rules 140 or Incentive Distribution Data 145 in Modify Data Step 315 allows incentive programs to be adjusted for particular circumstances such as special performance or business need. Modifications can be temporary, applying to a limited set of Incentive Distribution Data 145, or persistent, applying to Plan Rules 140 used to calculate Incentive Distribution Data 145, until modified again. Following Modify Data Step 315 the modifications to Incentive Distribution Data 145 are flagged as “Pending.”

In an Approval Required Step 320, Approval Engine 155 is used to determine a level of approval required for the modification made in Modify Data Step 315 to be re-characterized from “Pending” to “Approved.” In some embodiments, approvals are classified into at least two types, automatic and manual. In other embodiments, all approvals are automatic or all approvals are manual. Automatic approvals are those that can be granted without human input while manual inputs are those requiring human input. Automatic approvals are typically provided using Approval Engine 155 and a set of approval rules. As described further herein, manual approvals are typically obtained from a person associated with a node in Hierarchical Data Structure 200. If only an automatic approval is required, then that approval is attempted by Approval Engine 155 and the method is complete. If the attempt fails, then the modifications made in Modify Data Step 315 are reversed.

The type of approval required and/or persons whose approval is required is responsive to details of the modification and/or the business objects affected. For example, in some embodiments, modifications involving more than a specific amount of money require a specific level of approval. In some embodiments, approval is required from a supervisor of the person who made the modification. In some embodiments, approval is required from a supervisor of a person whose incentive is affected by the modification. Approval is optionally required from multiple sources (e.g. several people).

In an Identify Business Object Step 325, a member of Business Objects 210A-210W having approval authority for the “Pending” modification is identified using Approval Engine 155. Identify Business Object Step 325 uses Hierarchical Data Structure 200, Role Data 130 and optionally Approval Authority Data 135. Hierarchical Data Structure 200 is used to navigate to a member of Business Objects 210A-210W having an “Approver” role as indicated by Role Data 130. Optionally, this navigation starts at a member of Business Objects 210A-210W affected by the modification. When a member of Business Objects 210A-210W, having an “Approver” role is identified, Approval Authority Data 135 is optionally used to determine if approval from this particular member of Business Objects 210A-210W is appropriate with respect to the current “Pending” modification. If not, then the search is continued. If so, then Identify Business Object Step 325 is complete. In alternative embodiments, the determination of approval authority occurs later in the method. By using Hierarchical Data Structure 200 to identify a member of Business Objects 210A-210W, typical embodiments of the invention do not require use, development or management of an independent set of workflow rules.

In a Request Approval Step 330 a request for approval of the “Pending” modification to Incentive Distribution Data 145 is sent, using Output Interface 170, to the business object identified in Identify Business Object Step 325. In various embodiments, the request includes text and/or graphics and is sent using using e-mail, an addition to a task list of the business object, a meta-language based interface, a program executing on Client 115, a printed document, or the like. In response to the request, the identified business object may grant, deny or, in some embodiments, defer the request to another member of Business Objects 210A-210W.

In a Process Response Step 335, a response to the request for approval, sent in Request Approval Step 330, is received and processed. The response may include, for example, approval, denial, deferment, a timeout, or the like. A denial typically ends the process and the modification is undone. In some embodiments, processing of the response includes changing the status of the “Pending” modification accordingly. For example, if the response includes approval then the status is changed from “Pending” to “Approved.” However, in some embodiments approval may be sought from several members of Business Objects 210A-210W. In these embodiments, a denial response from a particular member of Business Objects 210A-210W is optionally sufficient to change the status of a modification of Plan Rules 140 from “Pending” to “Denied,” while an approval response may be insufficient to change the status of the change from “Pending” to “Approved”. In some embodiments, the method is completed with Process Response Step 335. However, in embodiments wherein additional approval may be required, the method continues to a Determine Authority Step 340.

In Determine Authority Step 340, one or more approvals received for a “Pending” change to Incentive Distribution Data 145 are compared with requirements for changing the status of the change from “Pending” to “Approved.” These requirement are typically included in Approval Authority Data 135. For example, in one embodiment, a modification of Incentive Distribution Data 145 requires approval from the immediate supervisor of an affected member of Business Objects 210A-210W and at least one manager. In one embodiment, a modification of Incentive Distribution Data 145 including an amount over a specific value requires approval from at least one member of Business Objects 210A-210W with special authority. In some embodiments, modification of Plan Rules 140 generally requires greater authority for approval than modification of Incentive Distribution Data 145.

In an Authority Sufficient Step 345, the result of the comparison made in Determine Authority Step 340 is evaluated. If the authority is sufficient the method continues to an Approve Change Step 350. If the authority is not sufficient the method continues to an Identify Business Object Step 355.

In Approve Change Step 350, the status of the modification to Incentive Distribution Data 145 is changed from “Pending” to “Approved.” In some embodiments, this step includes elimination of data configured to reflect a state of Incentive Distribution Data 145 prior to the modification.

In Identify Business Object Step 355, a member of Business Objects 210A-210W having approval authority for the “Pending” modification is identified using Approval Engine 155. In typical embodiments, Identify Business Object Step 355 includes the same processes as Identify Business Object Step 325. However, in Identify Business Object Step 355, any member of Business Objects 210A-210W to whom a request for approval regarding the current modification of Incentive Distribution Data 145 has already been sent, is not considered for identification. In addition, in some embodiments, a member of Business Objects 210A-210W having been previously identified, for the purpose of receive an approval request, using Identify Business Object Step 325 or Identify Business Object Step 355, is used as a starting point for navigating Hierarchical Data Structure 200. For example, in one embodiment, a change to Incentive Distribution Data 145 affecting Business Object 210T must be approved by both Business Objects 210I and 210F. In this embodiment, Business Object 210I is identified in Identify Business Object Step 325, and in Identify Business Object Step 355 Approval Engine 155 is used to navigate within Hierarchical Data Structure 200 from Business Object 210I to Business Object 210F.

In a Request Approval Step 360, a request for approval of the pending modification of Incentive Distribution Data 145 is sent to the member of Business Objects 210A-210W identified in Identify Business Object Step 355. Request Approval Step 360 includes processes of Request Approval Step 330. In a Process Response Step 365, a response to the request sent in Request Approval Step 360 is received and processed. Process Response Step 365 includes the processes of Process Response Step 335. The method then returns to Determine Authority Step 340.

In one embodiment of the methods illustrated by FIG. 3, a manager in charge of an Ohio sales territory (Business Object 210F) uses Data Modification Engine 150 to change Plan Rules 140 or Incentive Distribution Data 145 such that relative distribution of incentives between a hardware sales group (Business Object 210I) and a software sales group (Business Object 210J) is altered. Because Business Object 210F has a supervisory role relative to Business Objects 210I and 210J, the search for a member of Business Objects 210A-210W, having an “Approver” role starts at Business Object 210F. Approval Engine 155 is used to navigate within Hierarchical Data Structure 200 from Business Object 210F to Business Object 210C. If Business object 210C has an “Approver” role and approval authority to approve changes to Plan Rules 140 or Incentive Distribution Data 145 made by Business Object 210F, then Identify Business Object Step 235 is complete.

In one embodiment of the methods illustrated by FIG. 3, a supervisor of software sales in Ohio (Business Object 210J) raises an incentive offered to Business Object 210V by a large amount. In this example, Approval Engine 155 navigates within Hierarchical Data Structure 200 from Business Object 210J to Business Object 210F. At Business Object 210F Approval Engine determines, using Approval Authority Data 135, that Business Object 210 does not have approval authority to approve such a large amount of incentive. Approval Engine 155 then uses Hierarchical Data Structure 200 to navigate to Business Object 210C and uses Approval Authority Data 135 to determine that Business Object 210C has sufficient authority to grant approval.

In one embodiment of the methods illustrated by FIG. 3, a supervisor of a Kansas sales territory (Business Object 210E) changes Plan Rules 140 such that an incentive for a director of software sales in Ohio (Business Object 210J) is reduced. In this example, Approval Engine 155 uses Hierarchical Data Structure 200 to navigate from Business Object 210J (the affected member of Business Objects 210A-210W) to Business Object 210F and then to Business Object 210C if the approval authority of Business Object 210F is not sufficient.

In another example, in one embodiment of Identify Business Object Step 325, a manager of a channel partner company (Business Object 210H) makes a change in distribution of incentive between Business Objects 210R and 210S by modifying Incentive Distribution Data 145. In this example Approval Engine 155 determines, using Approval Authority Data 135, that no approval is needed by other members of Business Objects 210A-210W. However, Approval Engine 155 may optionally seek approval using some other hierarchical data structure associated with the channel partner company.

In alternative embodiments of the method shown in FIG. 3, all members of Business Objects 210A-210W, from whom approval, of a modification of Plan Rules 140 is required, are identified in Identify Business Object Step 325. In these embodiments, Request Approval Step 330 and/or Process Response Step 335 optionally include sending requests and/or receiving responses from more than one or all of the identified business objects. In these embodiments, a need for performing steps 355-365 may be eliminated.

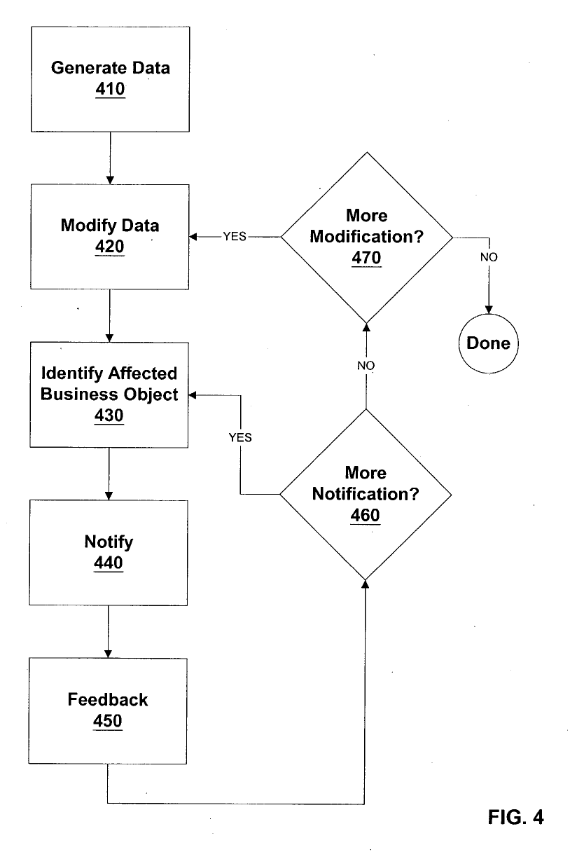

In addition to using Hierarchical Data Structure 200 to seek approval of a modification to Plan Rules 140 and/or Incentive Distribution Data 145, various embodiments of the invention include systems and methods of using Hierarchical Data Structure 200 to provide notice of these modifications. For example, FIG. 4 is a flowchart illustrating a method of using Hierarchical Data Structure 200 to provided notice relating to an incentive plan, according to various embodiments of the invention. The notice provided is regarding a modification and/or an addition to Plan Rules 140, regarding a modification and/or addition to Incentive Distribution Data 145, or regarding generation of a new incentive allocation plan. In some embodiments, the method of FIG. 4 is performed using Approval Engine 155. In other embodiments, the method of FIG. 4 is performed using a separate Notification Engine 165 (FIG. 1). In an optional Generate Data Step 410, Plan Rules 140, characterizing a plan for incentive management, is generated. Generate Data Step 410 is optional when the part of Plan Rules 140 to be modified already exists. In some embodiments of Generate Data Step 410, Plan Rules 140 are generated using plan rules derived using Hierarchical Data Structure 200.

In a Modify Data Step 420, Plan Rules 140 are modified using Data Modification Engine 150. In some embodiments, the modification includes addition of new Plan Rules 140 and/or changes to previously existing Plan Rules 140. In some embodiments, the modification includes addition of new Incentive Distribution Data 145 and/or changes to previously existing Incentive Distribution Data 145. Modification may be responsive to input from a compensation administration, manager, external process, or the like. In some embodiments, the source of the input to which modification is responsive is one of Business Objects 210A-210W associated with Hierarchical Data Structure 200. For example, in one embodiment, Business Object 210F is a manager of an Ohio division and this manager decides to modify the incentives given to hardware and software groups, these incentives being represented by Incentive Distribution Data 145. In some embodiments, modification of Incentive Distribution Data 145 in Modify Data Step 420 allows incentive programs to be adjusted for particular circumstances such as special performance or business need. In some embodiments, the modification made in Modify Data Step 420 is subject to an approval process such as those illustrated in FIG. 3.

In an Identify Affected Business Object Step 430, one or more members of Business Objects 210A-210W are identified as being affected by the modification made in Modify Data Step 420. Identification is made by using Hierarchical Data Structure 200 to navigate between members of Business Objects 210A-210W. For example, if a modification is made affecting a western sales division managed by Business Object 210B, then Hierarchical Data Structure 200 is used to identify members of Business Objects 210A-210W that are associated with daughter nodes of the node associated with Business Object 210B. In an embodiment wherein only members of Business Objects 210A-210W on the next lowest level of Hierarchical Data Structure 200 are identified, a modification of Incentive Distribution Data 145 affecting incentives to Business Object 210B will result in identification of Business Objects 210G and 210H in Identify Affected Business Object Step 430. These members of Business Objects 210A-210W are identified by navigating within Hierarchical Data Structure 200 from Business Object 210B. In this embodiment, Business Objects 210G and 210H are optionally given an option of providing notice to further members of Business Objects 210A-210W, such as Business Objects 210K-210S. In one embodiment, wherein members of Business Objects 210A-210W are identified at multiple levels, Identify Affected Business Object Step 430 results in identification of Business Objects 210G-210H and 210K-210S. In the two above examples, the identified members of Business Objects 210A-210W are identified by navigating within Hierarchical Data Structure 200 from Business Object 210B.

In a Notify Step 440, the members of Business Objects 210A-210W identified in Identify Affected Business Object Step 430 are notified of the modification of Plan Rules 140 or Incentive Distribution Data 145. The notification typically includes text or graphics. In various embodiments, this notification is made using e-mail, an addition to a task list of the business object, a meta-language based interface, a program executing on Client 115, or the like. Notification is typically made using Output Interface 170. In an optional Feedback Step 450, notified members of Business Objects 210A-210W provide feedback to Notification Engine 160 in response to the notification received in Notify Step 440. The feedback can include, for example, an objection or acknowledgement of the change, a request that further members of Business Objects 210A-210W be notified, a request for further modification to Plan Rules 140 or Incentive Distribution Data 145, actual further modification of Plan Rules 140 or Incentive Distribution Data 145, or the like.

In a More Notification Step 460 the existence of any further requests for notification and/or the existence of any further modifications to Plan Rules 140 or Incentive Distribution Data 145 are considered. If there are further notifications requested, for example by a member of Business Objects 210A-210W in Feedback Step 450, then the method returns to Identify Affected Business Object Step 430. Likewise, if further modifications have been made to Plan Rules 140 or Incentive Distribution Data 145 then the method returns to Identify Affected Business Object Step 430. Otherwise, the method continues to a More Modification Step 470 wherein the existence of requests for further modifications of Plan Rules 140 or Incentive Distribution Data 145 are considered. If further modifications have been made, for example by a member of Business Objects 210A-210W in Feedback Step 450, then the method returns to Modify Data Step 420.

In alternative embodiments, the methods illustrated by FIG. 4 are used to provide notification of events other than modification of Plan Rules 140 and/or Incentive Distribution Data 145. For example, in various embodiments the methods of FIG. 4 are applied to other top-down communications. These communications optionally include information about sales totals, bonuses, new incentives, quotas, successes, sales progress, or the like. For example, in one embodiment Business Object 210A establishes new quotas for each geographic region, represented by Business Objects 210B-210D. In this example, Notification Engine 165 is used to navigate through Hierarchical Data Structure 200 to affected members of Business Objects 210A-210W using Identify Affected Business Object Step 430. Those members of Business Objects 210A-210W affected by the change in quotas are then notified using Notify Step 440. In another example, steps of FIG. 4 are used to provide notification of proposed incentive distributions. In this example, preliminary Incentive Distribution Data 145 is generated. This instance of Incentive Distribution Data 145 is preliminary in that it has not been audited or reviewed. Hierarchical Data Structure 200 is then used to identify affected members of Business Objects 210A-210W as in Identify Affected Business Object 430. Using Notify Step, 440 the affected members of Business Objects 210A-210W, or their supervisors, are notified of the planned incentive distributions. This notification gives members of Business Objects 210A-210W or their supervisors a chance to review the planned incentive distributions and approve, modify or disapprove of them, using Feedback Step 450, before the incentive distributions are actually made.

Various embodiments of the invention include systems and methods of both approving and providing notice of a modification of an incentive plan. These methods include both seeking approval of a modification to Plan Rules 140 and/or Incentive Distribution Data 145 as illustrated in FIG. 3 and providing notice as illustrated in FIG. 4. If the modification is not approved then steps shown in FIG. 4 are optionally used to provide notice of the denial. This notice can include, for example, identification of a member of Business Objects 210A-210W who denied the modification.

Several embodiments are specifically illustrated and/or described herein. However, it will be appreciated that modifications and variations are covered by the above teachings and within the scope of the appended claims without departing from the spirit and intended scope thereof. For example, while the discussion herein uses modification of Plan Rules 140 or modification of Incentive Distribution Data 145 in particular examples, generally the systems and methods of the invention can be applied to modification of incentive allocation data. Incentive allocation data comprising allocation rules, calculation rules and/or Incentive Distribution Data 145. In Addition, in various embodiments, systems and methods of the invention can be applied to transactions other than incentives. For example, in these embodiments, the approval and notification processes can be applied to transactions including sales, purchases, purchase costs, inventory allocation, allocation of financial resources, allocation of capital resources, tasks, steps in a process, compensation, quality control, billing or the like. In these embodiments related transaction data is modified in place of incentive allocation data.

I claim:

1. A system for administrating incentives, the system comprising:
a computing system including
a data modification engine configured to modify incentive allocation data, the incentive allocation data configured for allocation of incentives,
an approval engine configured to use a hierarchical data structure to identify a business object configured to receive a request for approval of a modification to the incentive allocation data, the hierarchical data structure configured to store organizational data representative of relationships between business objects,
a processing unit configured to execute the approval engine,
an output interface configured to output the request for approval, and
storage configured to store the incentive allocation data and the organizational data.

2. The system of claim 1, further including a client configured to display the request for approval to a user.

3. The system of claim 1, wherein the incentive allocation data includes plan rules.

4. The system of claim 3, wherein the incentive allocation data includes allocation rules.

5. The system of claim 3, wherein the incentive allocation data includes calculation rules.

6. The system of claim 1, wherein the incentive allocation data includes incentive distribution data.

7. The system of claim 1, wherein the storage is further configured to store role data indicative of roles that a business object is configured to take.

8. The system of claim 7, wherein the role data includes an approval role indicating that a business object is configured to receive the request for approval of a modification to the incentive allocation data.

9. The system of claim 1, wherein the storage is further configured to store approval authority data indicative of a business object's authority to approve the modification to the incentive allocation data.

10. The system of claim 1, wherein the business object configured to receive a request is identified by navigating within the hierarchical data structure to a business object having approval authority to approve the modification to the incentive allocation data.

11. The system of claim 10, wherein the approval engine is further configured to identify a second business object configured to receive a request for approval of the modification to the incentive allocation data.

12. A system for administrating incentives, the system comprising:
a computing system including
means for modifying incentive allocation data, the incentive allocation data configured for allocation of incentives,
means for using relationships between business objects to identify a business object configured to receive a request for approval of a
modification to the incentive allocation data,
means for executing the approval engine,
means for outputing the request for approval, and
means for storing the incentive allocation data and the organizational data.

13. The system of claim 12, further including means for displaying the request for approval to a user.

14. A request to approve a modification to incentive allocation data, the incentive allocation data modified using a data modification engine, the request being text or graphics, generated by an approval engine configured to identify a business object having an approval role and configured to receive the request for approval of a modification to the incentive allocation data.

15. The request of claim 14, wherein the incentive allocation data includes plan rules.

16. The request of claim 14, wherein the incentive allocation data includes incentive distribution data.

17. The request of claim 14, wherein the request includes a meta-language based interface.

18. The request of claim 14, wherein the request is sent via e-mail.

19. The request of claim 14, wherein the approval engine is further configured to use a hierarchical data structure configured to store organizational data representative of relationships between business objects, to identify the business object having an approval role.

20. A computer readable medium having embodied thereon data, the data comprising
computer code configured
for modifying incentive allocation data, the incentive allocation data configured for allocation of incentives,
for using a hierarchical data structure to identify a business object configured to receive a request for approval of a modification to the incentive allocation data, the hierarchical data structure configured to store organizational data representative of relationships between business objects,
for executing the approval engine, and
for outputing the request for approval.

21. A system for administrating incentives, the system comprising:
a computing system including
a data modification engine configured to modify incentive allocation data, the incentive allocation data configured for allocation of incentives,
a notification engine configured to use a hierarchical data structure to identify a business object configured to receive a notification of a modification to the incentive allocation data, the hierarchical data structure configured to store organizational data representative of relationships between business objects,
a processing unit configured to execute the notification engine,
an output interface configured to output the notification, and
storage configured to store the incentive allocation data and the organizational data.

22. The system of claim 21, further including a client configured to display the notification to a user.

23. The system of claim 21, wherein the business object configured to receive a notification is a business object affected by the modification to the incentive allocation data.

24. The system of claim 21, wherein the business object configured to receive a notification is identified by navigating within the hierarchical data structure.

25. The system of claim 24, wherein the notification engine is further configured to identify a second business object configured to receive a notification of the modification to the incentive allocation data.

26. A system for administrating incentives, the system comprising:
a computing system including
means for modifying incentive allocation data, the incentive allocation data configured for allocation of incentives,
means for using a hierarchical data structure to identify a business object configured to receive a notification of a modification to the incentive allocation data, the hierarchical data structure configured to store organizational data representative of relationships between business objects,
means for executing the notification engine,
means for outputing the notification, and
means for storing the incentive allocation data and the organizational data.

27. A notification of a modification to incentive allocation data, the incentive allocation data modified using a data modification engine, the notification including text or graphics and being generated by a notification engine configured to use a hierarchical data structure to identify a business object affected by the modification to the incentive allocation data, the hierarchical data structure configured to store organizational data representative of relationships between business objects.

28. The request of claim 27, wherein the notification engine is configured to output the notification to the identified business object.

29. The request of claim 27, wherein the notification includes an e-mail message.

30. A system for administrating incentives, the system comprising:
a computing system including
a data modification engine configured to modify incentive allocation data, the incentive allocation data configured for allocation of incentives,
an approval engine configured to use a hierarchical data structure to identify a business object configured to receive a request for approval of a modification to the incentive allocation data, the hierarchical data structure configured to store organizational data representative of relationships between business objects,
a notification engine configured to use the hierarchical data structure to identify a business object configured to receive a notification of a modification to the incentive allocation data, the business object configured to receive a notification being a business object affected by the modification to the incentive allocation data,
a processing unit configured to execute the approval engine and the notification engine,
an output interface configured to output the request for approval and to output the notification, and
storage configured to store the incentive allocation data and the organizational data.

31. A method of administrating incentives, the method comprising:
modifying incentive allocation data;
identifying a first business object having an approval role, the first business object being associated with a data structure representative of a relationship between the first business object and a second business object, the identification being made using the data structure representative of a relationship between the first business object and a second business object;
requesting an approval for the change in the incentive allocation data, from the first business object; and
processing a response to the request, the response being received from the first business object.

32. The method of claim 31, wherein the incentive allocation data includes plan rules.

33. The method of claim 31, wherein the incentive allocation data includes incentive distribution data.

34. The method of claim 31, wherein modifying incentive allocation data includes generating all or part of the incentive allocation data.

35. The method of claim 31, wherein the incentive allocation data is changed by a business object associated with the data structure representative of a relationship between the first business object and a second business object.

36. The method of claim 31, further including determining if the change to the incentive allocation data requires approval.

37. The method of claim 31, wherein an allocation to the second business object is affected by the change in the incentive allocation data.

38. The method of claim 31, wherein the first business object is represented by a first node in the data structure, and the second business object is represented by a second node in the data structure, the first node being between a root node of the data structure and the second node in a hierarchy of the data structure.

39. The method of claim 31, wherein the first business object is represented by a first node in the data structure, and the second business object is represented by a second node in the data structure, and the first business object is identified by navigating within the data structure from the second business object.

40. The method of claim 39, where in the first business object is identified using role data.

41. The method of claim 31, further including
determining an approval authority for the first business object, relative to the changed incentive allocation data;
identifying a third business object having an approval role, the third business object being associated with a data structure representative of a relationship between the third business object and the first business object, the identification being made using the data structure representative of a relationship between the third business object and the first business object;
requesting an approval for the change in the incentive allocation data from the third business object; and
processing a response to the request made to the third business object, the response being received from the third business object.

42. The method of claim 41, wherein the first business object is represented by a first node in the data structure representative of a relationship between the first business object and the third business object, and the third business object is represented by a second node in the data structure representative of a relationship between the first business object and the third business object, the second node being between a root node of the data structure and the first node in a hierarchy of the data structure.

43. The method of claim 42, wherein the data structure representative of a relationship between the first business object and the second business object and the data structure representative of a relationship between the first business object and the third business object, are the same data structure.

44. The method of claim 31, further including providing notice of the modification of the incentive allocation data.

45. The method of claim 44, wherein the notice of the modification is provided to a third business object identified using the hierarchical data structure.

46. The method of claim 31, further including identifying a third business object associated with the hierarchical data structure, the identification being made by navigating within the data structure to the third business object, and notifying the third business object of the modification of the incentive allocation data.

47. A method of administrating compensation, the method comprising:
modifying incentive allocation data;
identifying a first business object associated with a hierarchical data structure representative of a relationship between the first business object and a second business object, the identification being made by navigating within the data structure from the second business object to the first business object; and
notifying the first business object of the modification of the incentive allocation data;

48. The method of claim 47, wherein modifying incentive allocation data includes generating all or part of the incentive allocation data.

49. The method of claim 47, wherein an incentive of the first business object is affected by the modification.

50. The method of claim 47, further including receiving feedback from the first business object in response to the notification.

51. The method of claim 47, further including identifying a third business object associated with the hierarchical data structure, and notifying the third business object of the modification of the incentive allocation data.

52. The method of claim 47, where in the first business object is identified using role data.

53. A method of administrating transactions, the method comprising:
modifying transaction data;
identifying a first business object having an approval role, the first business object being associated with a hierarchical data structure representative of a relationship between the first business object and a second business object, the identification being made using the hierarchical data structure representative of a relationship between the first business object and a second business object;
requesting an approval for the change in the transaction data, from the first business object; and
processing a response to the request, the response being received from the first business object.

54. The method of claim 53, wherein the second business object is a business object affected by the change in transaction data.

55. The method of claim 53, wherein the transaction data relates to an allocation of financial resources.

56. The method of claim 53, wherein the transaction data relates to an allocation of capital resources.

57. The method of claim 53, wherein the transaction data relates to an allocation of inventory.

58. The method of claim 53, wherein the transaction data relates to a purchase.
